(19) United States
(12) Patent Application Publication
(10) Pub. No.: US 2008/0087611 A1
(43) Pub. Date: Apr. 17, 2008

(54) Chemical Metering System

(76) Inventor: Joseph H. Tomley, Moneta, VA (US)

Correspondence Address: LATIMER, MAYBERRY & MATTHEWS IP LAW, LLP, 13873 PARK CENTER ROAD, SUITE 106, HERNDON, VA, 20171, US

(21) Appl. No.: 11/872,381

(22) Filed: Oct. 15, 2007

Related U.S. Application Data
(60) Provisional application No. 60/851,306, filed on Oct. 13, 2006.

(51) Int. Cl. B01D 35/14; C02F 1/68

(52) U.S. Cl. 210/749; 210/88

(57) ABSTRACT

The present invention provides a complete, fully integrated system for chemical metering, computer software to control the system and methods for use with the system. In general, the chemical metering system comprises one or more means for holding at least one chemical, one or more means for moving at least one chemical to the fluid that is being treated, one or more means for moving the fluid that is being treated through the system, and a means for controlling the system such that at least one chemical is metered to the fluid being treated with high accuracy. In a preferred embodiment, the present invention is used for residential applications or for low flow/low volume industrial and commercial applications.

### CROSS-REFERENCE TO RELATED APPLICATIONS

This application relies on the disclosure of, and claims the benefit of the filing date of, U.S. Provisional Patent application No. 60/851,306, filed 13 Oct. 2006, the entire disclosure of which is hereby incorporated herein by reference in its entirety.

### BACKGROUND OF THE INVENTION

1. Field of the Invention

The present invention relates to the field of chemical treatment systems. More specifically, the present invention pertains to a fully integrated chemical containment and injection system and methods.

2. Description of Related Art

Chemical injection or metering for treatment of fluids is a well known practice. Chemical metering can be used for such diverse applications as cleaning and sanitizing of water for human consumption and use, and for pesticide, herbicide, fertilizer, or pharmaceutical usage in agriculture and medicines, antibiotics, or hormone usage in the livestock industry. The benefits of chemical treatment are widely understood and recognized in large public and commercial systems that treat surface water sources for drinking. The chemical treatment of small scale, household-sized, groundwater systems presents significant challenges that have not been met.

There are two basic methods currently in use to chemically treat groundwater sources: 1) chemical shock treatment of the water in the well, and 2) chemical treatment of the water after being pumped out of the well using chemical dosing systems referred to as point of entry (POE) treatment systems. The basic distinction is that the shock method treats the water in the ground and the POE system treats the water at the point of entry into the building or into an above ground water storage unit. Issues such as chemical overdosing, the potential for ground water contamination, and long term effectiveness of shock treatment have discouraged but not eliminated the practice. In this respect, POE systems have distinct advantages. While shock treatment is common, POE methods of water treatment have not been extensively applied to small residential and commercial groundwater applications due to a number of feasibility issues including performance, service, design, integration of available products, the lack of industry product performance or system design standards, and the overall expense and limited availability of qualified system designers and installers for small scale systems. As a whole, it is widely accepted that currently available POE equipment and methods do not perform adequately for smaller sized applications.

The demand for POE systems in households and small commercial entities served by a single well, and those end-users served by a private water system where two or more end-users may be supplied by the same groundwater source, is increasing for a number of health, environmental, and other practical reasons. As the public is becoming more educated about water quality, the demand for better drinking water is on the rise. People are searching for means not only to make their water safe, but also to reduce organic and non-organic contaminants, bad odors, and bad taste.

There are fundamental design challenges in scaling down a water treatment system (WTS) for small scale end-users including water use issues such as low flow rates, variable flow rates, intermittent on/off cycling, and low total water usage. Equipment issues include ultra low dosing rate, pump drive control and dosing resolution, complete treatment system control and resolution, chemical containment and fittings, and system versatility and component compatibility. Chemical media challenges include the ability to deal with harsh/aggressive/unusual chemical properties, equipment material compatibility and resistance, safety and handling, manageable storage considerations and food grade traceability. Finally, engineering challenges also need to be addressed, such as industry recognition and certifications, lack of industry standards for small scale (residential) use, integrating system components, system performance, service and maintenance, installation, pump design limitations, and proper containment systems.

There is a need in the art for a complete, fully integrated chemical treatment system that comprises a high resolution proportioning chemical injection system featuring low dose rates and a high purity, air-tight chemical containment system that is easy to use and designed for extended, maintenance-free performance.

### SUMMARY OF THE INVENTION

The present invention addresses needs in the art by providing a system and methods for chemical treatment and/or purification of liquids. The present invention provides a complete, fully integrated system for chemical metering. In general, the system comprises an instrument for automated chemical metering, computer software to control the instrument and inject chemical substance(s), and methods of injecting one or more chemicals. The system is an integrated system of multiple independent parts and features that is designed to interconnect to provide the user the ability to inject numerous chemicals in precisely regulated amounts over a desired time-frame.

In a first aspect, the invention provides an instrument for injecting one or more chemicals of interest. In general, the instrument provides means for housing internal components, parts, elements, etc. of the instrument; means for storing at least one chemical composition in a containment source; means for moving at least one chemical composition from a chemical containment source to at least one liquid that is being treated and/or purified; means for moving the liquid that is being treated through the instrument; and means for controlling the means for moving at least one chemical composition, means for controlling the means for moving at least one liquid that is being treated and/or purified, or both.

In another aspect, the invention provides a system for metering at least one chemical into at least one fluid. In general, the chemical metering system comprises one or more means for holding or containing at least one chemical, one or more means for moving at least one chemical to the fluid that is being treated and/or purified, one or more means for moving the fluid that is being treated and/or purified through the system, and a means for controlling the system such that at least one chemical is metered to the fluid being treated with high accuracy.

In yet an additional aspect, the invention provides computing means for controlling a process of metering at least one chemical into at least one liquid that is being treated. In general, the computing means comprises software and, optionally, hardware for operating a computing device and executing software programs. The computing means can comprise commercially available hardware and software, and can use any of a number of standard components, computer languages, and the like.

In another aspect, the invention provides automated methods of injecting chemicals into at least one liquid. In general, the method comprises: storing at least one chemical in a chemical containment means; releasing the chemical(s) from the chemical containment means; exposing the liquid that is to be treated to the chemical(s); and treating at least one liquid with the chemical. In one of many optional steps, the method comprises initially adding at least one chemical to a chemical containment means. In embodiments, the liquid that is being treated is water. In the method, most of the steps are performed automatically by a machine, such as one controlled by a computer program. In other words, most of the steps of the method do not require human interaction or human action, although certain optional steps (e.g., adding a chemical to the containment means) may include some human action.

### BRIEF DESCRIPTION OF THE DRAWINGS

The accompanying drawings, which constitute a part of this specification, illustrate several embodiments of the invention and, together with the written description, serve to explain various principles of the invention. It is to be understood that the drawings are not to be construed as a limitation on the scope or content of the invention.

FIG. 1 depicts an embodiment of the system of the invention in which water or another liquid is being treated.

FIG. 2 shows an embodiment of a pump controller according to the present invention.

FIG. 3 depicts an embodiment of the chemical containment system according to the present invention.

FIG. 4 shows the same embodiment as FIG. 3 and shows the container closure and connector system in more detail.

FIG. 5 depicts the same embodiment as FIGS. 3 and 4 and shows the free flow puncture tip in more detail. Panel A depicts a side view and Panel B shows a front view.

FIG. 6 shows an embodiment of the pulseless cam and switch assembly contained within the pump controller of the present invention, which allows for precise, continuous flow of small volumes of liquid into the fluid stream.

FIG. 7 depicts an embodiment of the flow monitor assembly.

FIG. 8 depicts one embodiment of a computer program flow chart for implementing a method of the invention.

### DETAILED DESCRIPTION OF VARIOUS EMBODIMENTS OF THE INVENTION

Reference will now be made in detail to various exemplary embodiments of the invention, some of which are depicted in the figures. The following description is provided to give details on certain embodiments, features, and details of the invention, and should not be understood as a limitation on the full scope of the invention.

Broadly speaking, the present invention provides a chemical metering system and methods for injecting one or more chemicals of interest into a liquid for treatment and/or purification. The present invention can be applied to residential, office, public, commercial, industrial, agricultural, and any other application that requires the treatment of a liquid, either for purification, for addition of beneficial or otherwise desirable substances, or any other reason. Purification of a liquid means that at least one compound or substance is being removed from the liquid, resulting in a more pure liquid. Treatment means that at least one chemical is being added to the liquid to change some characteristic of the liquid, such as eliminating an undesirable substance from the liquid or making the liquid more pure or resulting in less odor or better taste. For example, the system can be utilized to eliminate pesticides or other harmful substances from a fluid by the addition of certain chemicals. In an alternative case, the system can also be used to inject pesticides into a fluid for purposes of agricultural use. Likewise, the system can be used to add one or more antibiotics or growth-enhancing agents into water to be used for consumption by farm animals. For purposes of the present invention, treatment and purification are used interchangeably, and the terms are broadly used to mean that a liquid is being treated in such a way that at least one characteristic of the liquid is changed. In one embodiment, the present invention is a high-purity, air-tight, no-spill, small volume, complete chemical containment system that is easy to use and designed for extended, maintenance-free performance. In this embodiment, the present invention is particularly suited for residential applications, such as for a household-sized water purification system, or for low flow/low volume industrial and commercial applications.

According to the method and system of the invention, the chemical(s) are injected into at least one liquid for treatment of the liquid. By injecting, it is meant that at least one chemical is added to a liquid. Injecting can occur by pressure from a pump, by the addition of the chemical by gravity, or any other means that allows the chemical to be added to the liquid. Preferably, the chemical(s) are added by way of a pulseless pumping mechanism that allows for continuous (or essentially continuous) pumping of the chemical into the liquid, even at very low flow rates of chemical and/or liquid to be treated. The present invention is applicable to any liquid that is treated with a chemical or chemical composition. In this context, chemical and chemical composition are used interchangeably and can refer to a single chemical or to a mixture of more than one compatible chemical. Any chemical that can be used for treatment of a liquid can be employed in the present invention. It is a particular advantage of embodiments of the present system that harsh, aggressive, dangerous, and/or toxic chemicals can be utilized in treatment because the user does not need to handle the chemical directly. In addition, the materials used for making the instrument, such as polyethylene for the tubing, are selected to be chemically resistant to the chemical(s) to be used, and the system is designed to have few wetted components, thus allowing highly corrosive chemicals to be injected without degradation of the system. As an example, bleach can be used in the instrument for treatment of a fluid, commonly known in the art as a difficult chemical to inject. Examples of chemicals that can be injected include, but are not limited to, sodium compounds (such as sodium carbonate, sodium phosphate, and sodium silicate), inorganic phosphate compounds (such as phosphoric acid and pyrophosphates), organic phosphoric compounds (such as alkyl phosphates and phosphonates), chelating agents (such as sodium and potassium phosphates), dispersants (such as those derived from acetate or acrylate), and oxidizers (such as chlorine, hydrochloric acid, or bleach). If more than one chemical is to be added for treatment, they can be added individually from separate chemical containment means or they can be added together in one chemical containment means if they are compatible. If more than one liquid is being treated, the liquids can be kept separate through the system or can be intermingled if that is appropriate. The term “liquid” also encompasses liquid suspensions that may be dispensed if properly dispersed with agitation or chemical dispersing agents or surfactants. Although liquids are the primary embodiment of the present invention, it is envisioned that gasses may also be injected as long as the tubing and other parts of the instrument are not gas permeable. Thus, the invention is broadly directed to use with fluids. In a preferred embodiment, the present invention can be employed to treat water for household use to control at least one of: taste, odor, turbidity, bacterial and/or viral contamination, heavy metal contamination, mineral deposits, water hardness, or any other undesirable characteristic.

In one general aspect, the invention provides a system for injecting one or more chemicals of interest. In general, the system provides at least one of the following: means for housing internal components of the instrument; means for storing at least one chemical composition; means for moving at least one chemical composition from a chemical containment source to at least one liquid that is being treated, means for moving the liquid that is being treated through the system, and a means for controlling the system. Typically, the system comprises a machine or instrument that comprises at least one pump for controlled, precise addition of at least one chemical into a fluid. The pump is capable of pumping precise, small volumes of fluid without significant gaps, pauses, or pulses in pumping of the fluid(s), and thus can continuously provide a specific, precise amount of fluid as an additive to another fluid, which is to be treated. In addition to the pulseless pump, the system typically comprises sufficient tubing or other conduits for movement of chemicals from a holding compartment (e.g., container) to a fluid to be treated. The conduits and all fasteners, couplings, seals, etc. are selected to have a material composition that is resistant to degradation or decomposition by the chemical(s) to be conducted from the holding container to the fluid to be treated.

From another perspective, the system is a system that treats a fluid, said system comprising at least one chemical storage container, at least one pump for pumping chemical from the chemical storage container to a container comprising a fluid to be treated, at least one pump controller to cause pulseless movement of fluid from the pump(s), at least one flow monitor assembly to monitor the amount of chemical added to the fluid to be treated, and at least one conduit for conducting the chemical from the chemical storage container to the container comprising the fluid to be treated. The chemical storage container(s) may be disposable. The flow monitor assembly may comprise a dip tube, dip tube connector, and supply tubing, which comprise one piece. The pump controller may comprise a pulseless cam and switch. The system can further comprise a power supply and/or a computing device, wherein the system is an automated system in which movement of fluid and chemicals is controlled by the computing device. The power supply may be a VDC power supply. In one embodiment, the system does not comprise any open containers. The system may comprise a chemical storage container, power supply, pump, pump controller, and flow monitor assembly which are enclosed in a single shell, thereby making the system portable. The system may be used for water treatment or purification, such as for a single household. The chemical dosing rate into the fluid that is being treated may be approximately at or below 0.1 milligrams/liter.

As another example, the present invention provides an instrument for precise addition of at least one chemical into a fluid. The instrument may comprise at least one pump to pump at least one chemical from a first container into a second container containing a fluid to be treated with the chemical, at least one conduit connecting the pump(s) to the second container, at least one pump controller to cause the pump(s) to move fluid in a pulseless manner, and at least one flow monitor to monitor the flow of chemical(s) into the second container. The instrument may be capable of precise, constant delivery of chemical to the fluid at less than 1 part per million variance. The instrument may further comprise at least one power supply for powering the pump(s), controller(s), and/or monitor(s). It may be capable of delivery of a chemical at less than 100 parts per billion variance. In one embodiment, the instrument delivers at least one chemical to water.

In an exemplary embodiment, the instrument, and its corresponding system, can be used for chemical metering for small scale applications. The ability of the system to have the control and precision to inject small amounts or volumes of chemicals to treat a fluid is a significant departure from large scale systems that are used for the same purpose. In contrast to other solutions for providing small scale systems (which relied simply on reducing the size of equipment and the volumes of fluids processed), the present system provides a wholly redesigned concept for purification and treatment of liquids on a home- or farm-scale. For example, the system is modular, allowing for replacement of certain elements (e.g., containers, tubing) without the need to repair the entire system. Furthermore, the system uses a pulseless pumping scheme to deliver a continuous stream of chemical(s) to the fluid to be treated, rather than providing a system that pulses or dopes relatively large volumes of treatment chemicals into the fluid to be treated, relying on a long-term average concentration of chemicals to provide effective treatment.

Other advantages of embodiments of the system include, but are not limited to, portability that allows the use of the system in different environments, ability to exchange, add, or delete different parts of the system, and safer handling of chemicals that are used for treatment of a liquid. For example, the use of relatively small containers to hold chemicals reduces the total volume of chemicals exposed to the air and reduces release of the chemicals into the air (which can be significant for highly volatile chemicals and can pose a significant danger if used in-house under poor ventilation conditions).

The system of the invention can include all of the mechanical components needed to implement a treatment or purification method of the invention. It thus can include connectors and the like for attaching the instrument of the invention to a supply of fluid to be treated, such as a plumbing system of a house, a plumbing system of a farm, or a plumbing system of a small group of dwellings or commercial properties. It is to be noted that the system is fully scalable, and thus can be used for large-scale treatment of fluids; however, particular advantages are realized when the system is implemented in a low-volume setting.

In another general aspect, the invention provides a system for metering at least one chemical into at least one fluid, such as a liquid or gas. In general, the system provides at least one of the following: means for housing internal components of the instrument; means for storing at least one chemical composition; means for moving at least one chemical composition from a chemical containment source to at least one liquid that is being treated, means for moving the liquid that is being treated through the system, and a means for controlling the system. In this aspect, the system allows the chemical to be added to the liquid with high accuracy and low dosage if needed. For example, in one embodiment, the dosing rates are approximately at or below 0.1 milligrams per liter. With this system, low residual chemical treatment methods may be easily maintained to assure effectiveness and extend the chemical contact time. In one embodiment, the system comprises at least one chemical storage container, at least one power supply, at least one pump, at least one pump controller, at least one flow monitor assembly, and tubing to allow flow of the liquid that is being treated and flow of the chemical composition. In another embodiment, the instrument comprises some of the components, but not others. For example, the instrument can comprise at least one power supply, at least one pump, at least one pump controller, at least one flow monitor assembly, and tubing to allow the flow of liquid. In this case, the chemical storage container may be added later to the instrument by the user, depending on the application. In another example, the instrument can comprise at least one pump, at least one pump controller, at least one flow monitor assembly, and tubing to allow the flow of liquid. In this case, the chemical storage container and at least one power supply can be added later to the instrument. Due to the modular nature of the system, certain components may be removed and replaced, or added at a later time, as desired by the user.

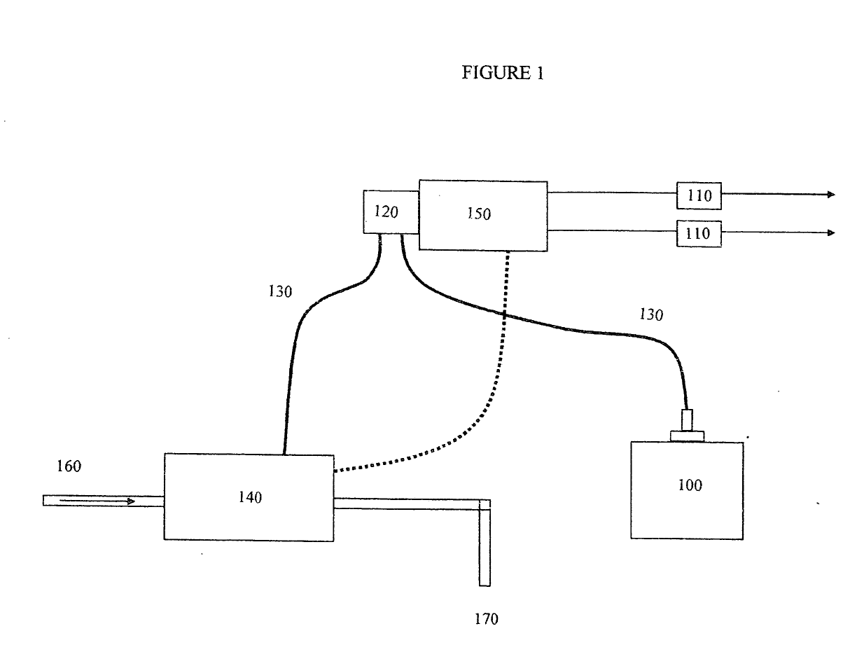

Turning now to the figures, a preferred embodiment of the present invention will now be explained in more detail. FIG. 1 depicts a water purification process, where at least one chemical is added to a chemical containment means 100. External power from at least one power supply 110, and preferably two power supplies, allows a pump 120 to move the chemical from the containment means 100 through the tubing 130 to a flow monitor assembly 140. The external power supplies comprise alternating current (AC) to direct current (DC) with a low voltage system of preferably less than 28 Volts DC. In embodiments, two external desktop-type, primary power supplies are 5 VDC rated at less than 25 watts and 24 VDC rated at 70 watts. The power supplies are fitted with DC plug-in connectors on extension wiring and fitted with universal AC connectors. AC extension cables for standard household outlets are available for short or extended runs.

In other embodiments, the number of VDC power supplies can be reduced from two to one. The system may be operated with a single source power supply in a voltage range from 12 to 24 VDC. Therefore, the system can operate using an “automobile type” battery and a hand or low voltage water pump. The portability of this instrument allows the system to be used in many different environments. This embodiment could be preferred in countries where contaminated water sources are used for drinking water and AC power is not readily available. This system would also be preferable in agricultural/farming communities where pesticide, herbicide, fertilizer, or pharmaceutical applications are required. As another example, the livestock industry can use the system for delivering medicines, antibiotics, hormones, etc. to animals.

The pump controller 150 controls the rate of chemical flow through the system, which allows the instrument to have high accuracy in dosing using low volumes of chemicals. Water from the water source 160 also flows through the flow monitor assembly 140 where the chemical is injected into the water. Finally, the treated water flows through to where it is subsequently used, such as in a home plumbing system 170. As can be seen from FIG. 1, the flow monitor assembly, pump controller, pump, and power supply can each be housed in a single, water resistant, enclosure. This simplifies installation, provides increased protection of components, and defines a compact, enclose, unitized, and manageable system that is portable and suitable in harsh environments. Optional components such as modems, pH and ORP monitors, communication connections, and other devices may be mounted inside any of these enclosures as well. With this unitary design, components are interchangeable and can be added, deleted, or exchanged with analogous components easily.

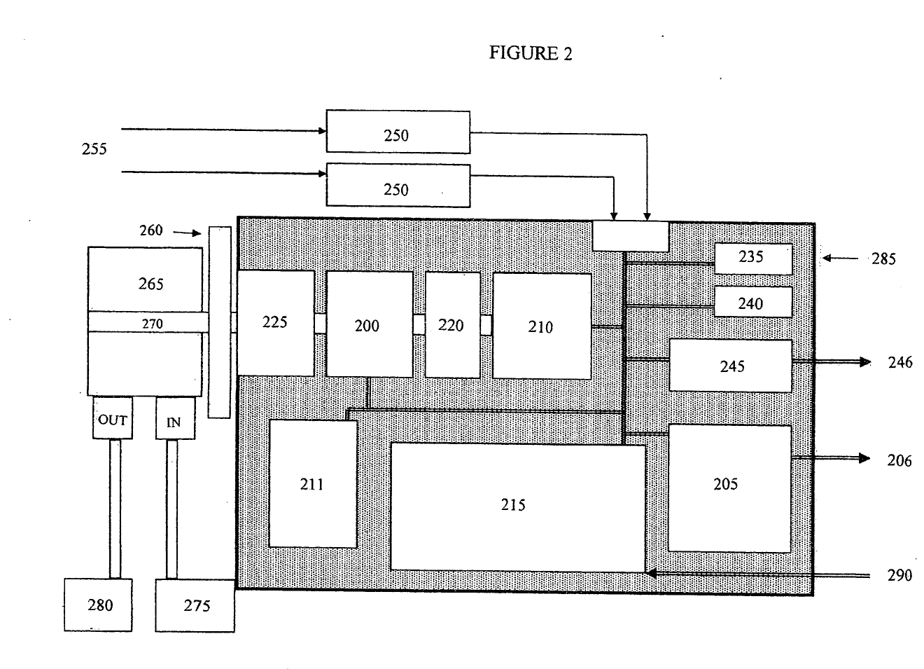

FIG. 2 depicts an embodiment of the pump controller. The enclosure or housing 285 houses the components of the pump controller. The enclosure may be made of metal and may be vented at the top and/or the bottom. Front and back panels allow access to the components of the pump controller. The pulseless mechanical cam-actuated switching module 200 can comprise a round cam with a metal, gear-like design that mounts on the pump shaft 270. The cam can also comprise equidistant points (e.g., teeth) that correspond to pump roller spacing and number to actuate the switch. In one embodiment, the cam is approximately 1 and ⅜ inches in diameter and 3/32 of an inch in thickness. The switch can be a miniature roller lever type or a similar long life, durable switch with normally open contact. The switch body is securely mounted with fasteners to the housing so the cam fully engages the switch without binding. The timing of the cam and switch is not achieved by adjusting the switch location; instead, the timing is controlled and calibrated by software.

The pulseless cam and switch 200 are software responsive and software calibrated via the programmable logic controller (PLC) 205. The PLC 205 comprises a pump controller program in relay ladder logic and is multi-point responsive to the flow of liquid and/or chemical, the operator, the program itself, and comprises expandable input points. The switch 200 can be an absolute positioning sensor that sends a signal to the software program via the PLC which in turn uses the signal to control the pump's function. In FIG. 2, because the cam is a three roller design, at every one-third revolution of the output shaft, the sensor sends a signal to the software to allow the actual triggering of the pulseless advance movement. A subprocess can be embedded in the software to calibrate the actual triggering of the pulseless advance movement. Once set, the process does not require re-calibration. This assures that the pump advances at the right time and position and for the correct duration and distance. The cam may have more or less intervals, depending on the pump (e.g., peristaltic pump) design. The term “multi-responsive” refers to the system processing multiple inputs and outputs, simultaneously, any of which advances the pump for priming, dosing, or pulseless advance according to the predetermined constants, operator manipulation, and realtime variables. This design allows the pump to fast forward past the no pressure zones and results in pulseless flow of liquid. The PLC can be connected to 24 V DC power. A communication link 206 connects the PLC 205 to an external communication system. The operator interface 215 allows the operator to change the settings of the pump controller and monitor the system. The interface may include information and/or allow changes to the pump controller such as flow meter input, input signal divider, external power source changes, pump priming, low chemical reset, injection rate control, and indicator reset. Flow meter wiring 290 allows monitoring of the flow. In one embodiment, there is a high speed input module for the PLC for flow monitors with pulse rates exceeding 20 pulses/second. The pulse-less operation of the system allows high accuracy of chemical dosage into the liquid being treated. The programmed auto advance feature corrects for pressure dead zones in the pump without dampeners. The computer control and use of a pulseless cam and switch design allows better control of chemical dosing, resulting in highly accurate dosing.

In one basic embodiment, the operator interface is a panel mount, mini push button momentary type with a total of four primary (basic) functions. Of course, other functions can be added on to this component. Two insulated binding posts are utilized for external power 12-24 VDC for flow monitor. One insulated binding post is used for input of the flow monitor pulse. Binding posts have been selected over other type connectors for their adaptation characteristics. Switch #1 comprises a pump priming feature which advances the pump approximately one full revolution and will not interfere with normal pump controller operation and is wired to an input. Switch #2 comprises an input and has a dual operation as it is used to reset the low chemical indicator (audible chime and/or optional electronic communication link) and at the same time reset the internal chemical volume counter. Switch #3 has an input and is utilized for increasing, in minute increments, the chemical dosing rate per “adjusted” pulse or base pulse from the flow monitor (the input pulse may be divided). The base pulse of approximately 50 pulses per gallon provides sufficient resolution for slug-free dosing, and at this resolution each press of this switch increases the dosing rate approximately 0.1 ppm (using a 6% solution) beginning at a programmed default dosing rate of 0.5 ppm. Switch #4 has an input and has a reset operation that restores the injection rate to the default rate of 0.5 ppm. Other inputs are reserved for optional operator controls and/or optional equipment sensing, control and communication devices.

Other components of the pump controller include a step motor (direct current) 210 with a step motor driver 211, a gear box (e.g., 4:1 reduction) 220, a drive shaft adapter 225, and plug-in power jacks 230. The step motor driver 211 is mounted inside the housing 285. It can be wired to 5V and 24 V DC power supplies and can be connected to PLC Y0 and Y1 output wiring. In one embodiment, the step advance is set to achieve 0.36 degrees per pulse or 1000 steps per revolution of the step motor. In one embodiment, the step motor 210 is of the type NEMA 23 with direct current. In one embodiment, the gear box contains two metal gears, one a 36 tooth with approximately 1 and ⅝ inch and the second a 9 tooth with approximately ½ inch diameter. As can be seen from FIG. 2, the gear box 220 is fastened to the step motor drive shaft 210. The gear box 220 is also fastened to the enclosure 285. Optionally, a low chemical indicator 235 warns the operator when the chemical needs to be replaced. Also optionally, an indicator for leaking in the system 240 can be added. Additionally, a modem 245 can be used as a communication link to import/export data from/to the system through wiring 246. Power supplies 250 from household outlet 255 are connected to power jacks 230.

A pump mounting adapter 260 connects the pump controller to pump 265 through pump shaft 270. The pump controller housing may be fitted with a pump head from any one of a number of pump manufacturers without requiring significant internal hardware adaptation of the controller. External adaptation requires the appropriate mounting configuration to drive and secure the pump to the controller. Although there are significant differences in pump designs, the embedded program may be easily manipulated to affect the accurate, standardized chemical dosing performance of the system. In one embodiment, the pump shaft 270 is ⅜ diameter and is at least 2 inches long. It can be mounted in two bearings spaced to provide sufficient support in the radial and axial directions. One bearing can support the shaft end and can be mounted to the gear box 220 base plate and the other bearing can be mounted where the shaft exits the controller housing. At least one chemical flows through the pump from chemical containment 275 and flows out of the pump to the flow monitor assembly 280.

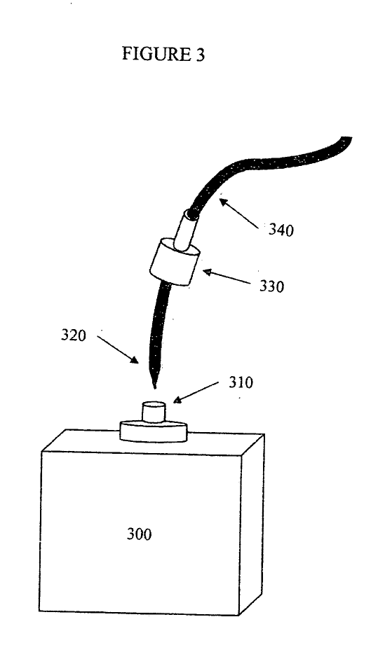

FIG. 3 depicts an embodiment of the containment system in which at least one chemical is contained in a collapsible bag in a box 300. The dip tube 320 fits in the nipple or closure 310 of the collapsible bag in a box 300. The dip tube connector 330 comprises a housing component (non-wet) and a one piece tubing and O-ring (wetted) component. The supply tubing 340 allows flow of the chemical(s) from the collapsible bag 300 to the pump (seen in FIG. 1). An unlimited number of kinds of chemical resistant collapsible bag and/or box containers can be used for the present invention. However, preferably the bag closure 310 and the dip tube connector 330 is a mated component specifically designed to overcome the difficulties of the chemical properties and handling and preferably is manufactured with precision for interchangeability purposes.

The collapsible bags and/or box containers are preferably disposable, pre-filled, sealed, no-spill, and transportable so that the user does not need to come in contact with the chemicals used for treatment. Therefore, concentrated, aggressive chemical solutions can be used in the system. The bags and/or boxes can contain low volumes for applications that do not require much chemical injection. The use of these containers eliminates the need for large volume, open solution tanks resulting in chemicals that will not evaporate and eliminates the service burden of maintaining large open tank systems. Additionally, the prepackaged chemical solutions are standardized and reduce the chemical replacement interval by allowing small and consistent dose rates of higher concentration chemicals. The present invention allows higher concentrations of chemicals because the sealed containers prevent the loss or breakdown of chemical media due to volatility and/or reaction to air, and the like. Additionally, the higher concentration also means more chemical per unit volume can extend the interval for replacement of the chemical.

The one piece tube design 330 maintains purity by reducing the number of wetted components, and reducing the introduction of air/gasses into the system by drawing the chemical from the bottom of the non-vented, collapsible container. The compression of a chemical resistant, FDA approved O-ring between the closure nipple face, the tubing and the connector/coupling body provides the sealing. The tubing tip features allow for the penetration of the nipple and prevents stoppage of the flow of chemical during use. The tubing can be polyethylene and the size can be ¼ inch (outside diameter). The design of the containment system allows protection for the user from the chemicals used for treatment as well as allows optimal performance of the system.

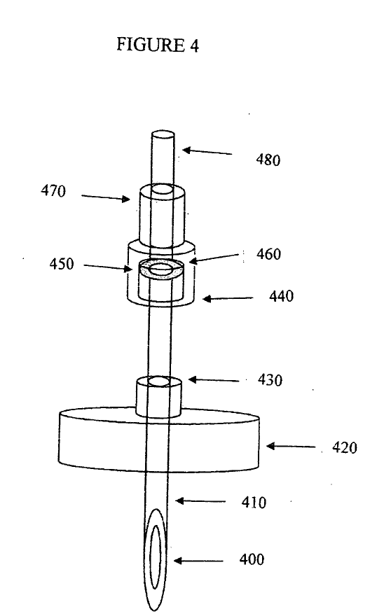

FIG. 4 depicts a close up view of part of the same embodiment of the containment system as seen in FIG. 3 with the dip tube 410 resting inside the container closure 420. The free flow puncture tip 400 is angle cut and notched, which assures the unobstructed and free flow of chemical media through the tubing 500. The dip tube 410 can be any length depending on the use. The closure 420 is part of the collapsible bag in a box (not shown). The nipple face 430 is comprised of an O-ring seat that can be of a puncture or non-puncture design. The remaining parts of the container closure and connector system are comprised of a screw or clip lock union 440, an O-ring seal 450, a molded O-ring seat in the connector body 460, a connector 470, and supply tubing 480. The one piece design of the supply tubing 480, which encompasses the tip of the dip tube tip to the pump head, allows less exposure of the user to the chemical(s) during handling and replacement of the chemical media and improves performance.

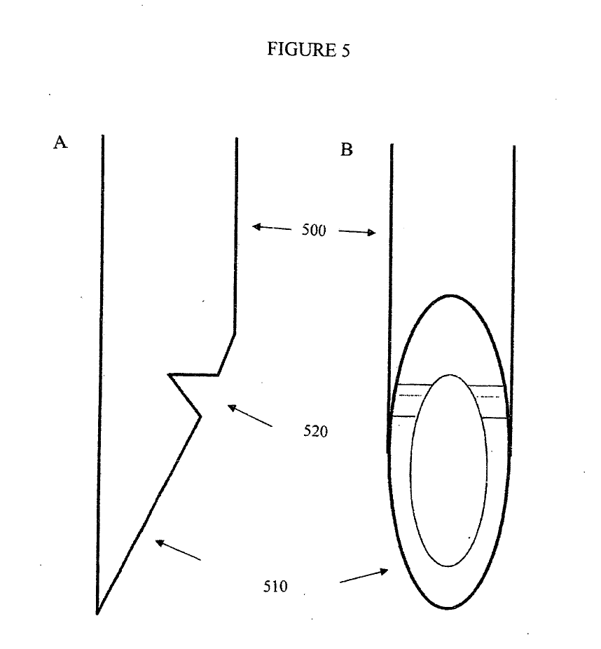

FIG. 5 shows an even closer view of the tubing tip seen in FIGS. 3 and 4. Panel A shows a side view of the tubing tip and Panel B shows a front view. The free flow puncture tip 510 is angle cut and notched 520. The dip tube and puncture nipple closure is a sealed connection that is sanitary and easy to use. Unlike most couplings, the dip tube helps prevent the introduction of gasses into the mainline tubing without interfering with flow and does not require turning the container upside down.

With this design of the tubing tip, dosing rates and flow rates can be highly accurate and low, if necessary (such as a dosing rate of below 0.1 milligrams/liter, a flow rate at or below 1.9 liters/minute (0.5 gallons/minute), or incremental injection rates below 0.1 parts per million (ppm), for example. Incremental injection rates and/or dosing rates can range from less than 1 part per billion (ppb) to up to 1000 ppm. For example, the range can be from 1 ppm to 1 ppb, such as 0.1 ppm, 0.05 ppm, 0.025 ppm, and 0.01 ppm. In addition, the upper range can be from 1 ppm to 1000 ppm, such as 1 ppm, 10 ppm, 100 ppm, 500 ppm, and 750 ppm. In a preferred embodiment, the chemical dosing rates are in increments of 1 milligram/liter at an average flow rate of 20 liters/minute (or 1 ppm at approximately 19 liters/minute). In the standard configuration of components, the proportional flow range is 0.8 gpm to 8 gpm and the operator's chemical dosing control is in increments of 1 ppm. The variance over time (precision) of the dosing, in a dosing range from 1 to 10 ppm, for example, can range from 1% to 10%.

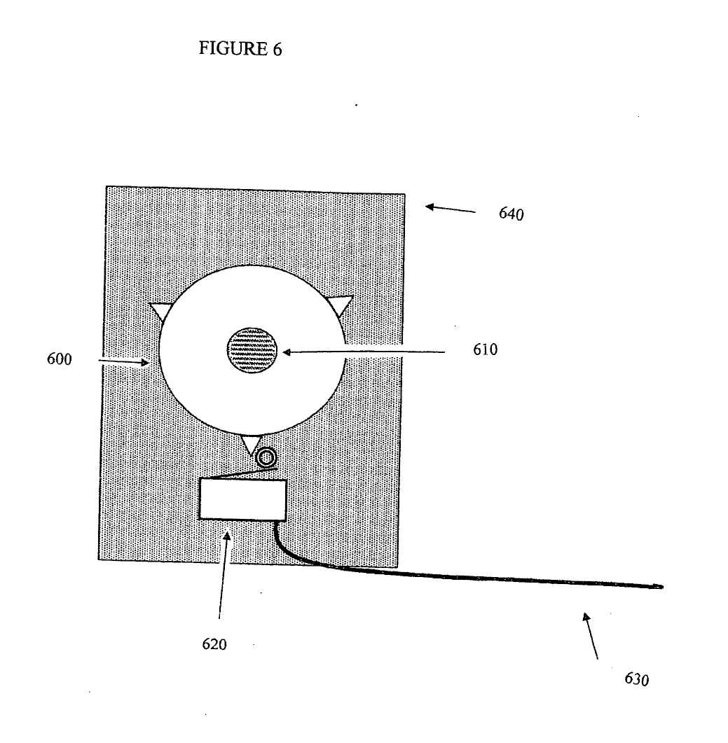

FIG. 6 depicts a detailed view of an embodiment of the pulseless cam and switch assembly. The cam 600 is shown with three equidistant high points around the circumference and is mounted to the drive shaft 610 (the view is shown along the drive shaft axis). The miniature switch 620 has a long life, low wear, and is of high repeatability type. The bidirectional rotation of the cam 600 triggers switch activation. The switch 620 is mounted to the housing 640 and is connected to switch wiring 630. The pump, cam 600 and switch 620 have programmable calibration ability and do not require manual adjustment.

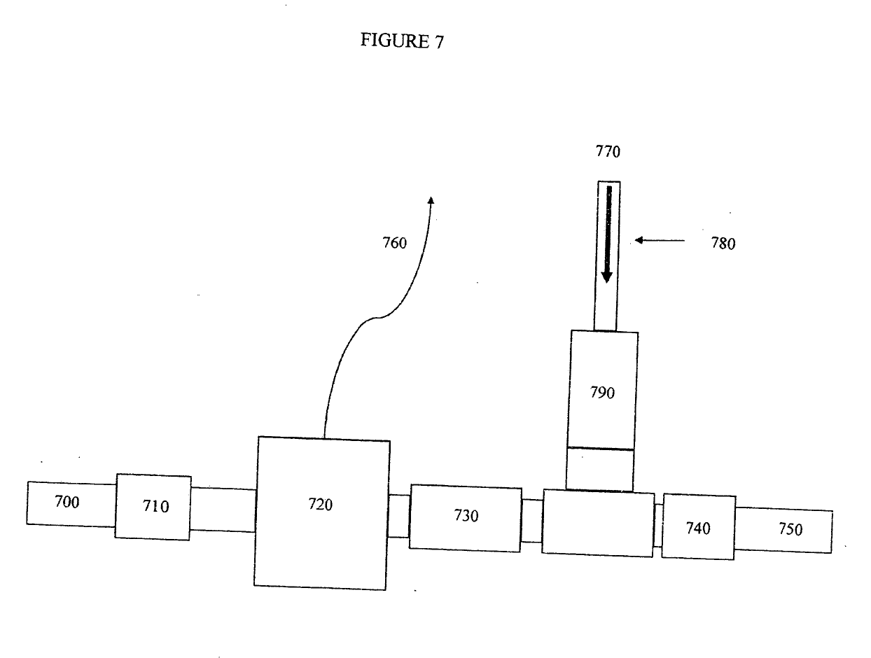

FIG. 7 shows an embodiment of the flow monitor and quill assembly. The flow monitor is comprised of an inlet (POE) piping 700, coupling 710, the flow meter with pulsed output 720, a check valve 730, and coupling 740. The chemical flow 770 flows through the injection pump tubing 780 and into the injection quill 790. After injection of the chemical, the treated liquid flows out through tubing 750. The output wiring to the pump controller 760 is also shown. The flow monitor, check valve 730, injection quill 790, connectors and fitments can be pre-assembled for ease of installation. In one embodiment, a flow monitor with a 100 pulse per gallon output is used for the optimum frequency/resolution for standard PLC inputs. Standard pipe thread, rated plastic or brass pipe, check valve and “tee” in ½ or ¾ inch diameter can be utilized. Preferably, the injection quill is a ¼ inch check valve type. Connectors at each end of the assembly can be push-in type and compatible with CPVC, PEX, or copper tubing and are incorporated to ease installation. Higher flow monitor resolution may be achieved with the optional PLC high speed input module. The flow monitor wiring requirements will vary with manufacturer; however the controller interface provides for all two or three wire installations. Some flow monitors identify specific requirements for proper performance, which may include special orientation or piping. The design of the assembly incorporates these requirements and helps prevent installation problems and poor system performance. The design also utilizes high pulse output flow monitors for better performance. In an embodiment, two sensors are used in the flow monitor for better control. In addition, the flow meter internal electronics are custom designed and software manipulated to improve performance by eliminating erroneous signal inputs to the pump controller which prevents chemical overdosing. For example, the flow meter internal electronics can be manipulated by subprocess 5 of one embodiment of the software program.

In another general aspect, the invention provides computing means for controlling a process of metering at least one chemical into a liquid that is being treated. In general, the computing means comprises software and hardware for operating a computing device and executing software programs. The computing means can comprise commercially available hardware and software, and can use any of a number of standard components, computer languages, and the like. In general, the computing means is designed to monitor the pumping action, and thus flow rate, of pumps of the system, to deliver precise amounts of chemical(s) (both liquid and gas) to a fluid to be treated. Feedback mechanisms from sensors allow the computing means to adjust flow rates of pumps to achieve desired levels of chemicals in the treated fluids, and to precisely maintain those levels throughout an extended period of time. Though the user may set the variation in chemical levels to any suitable range, the system is capable of precise monitoring, on the level of parts per million or even parts per billion, to achieve an essentially steady state of chemicals in a given system.

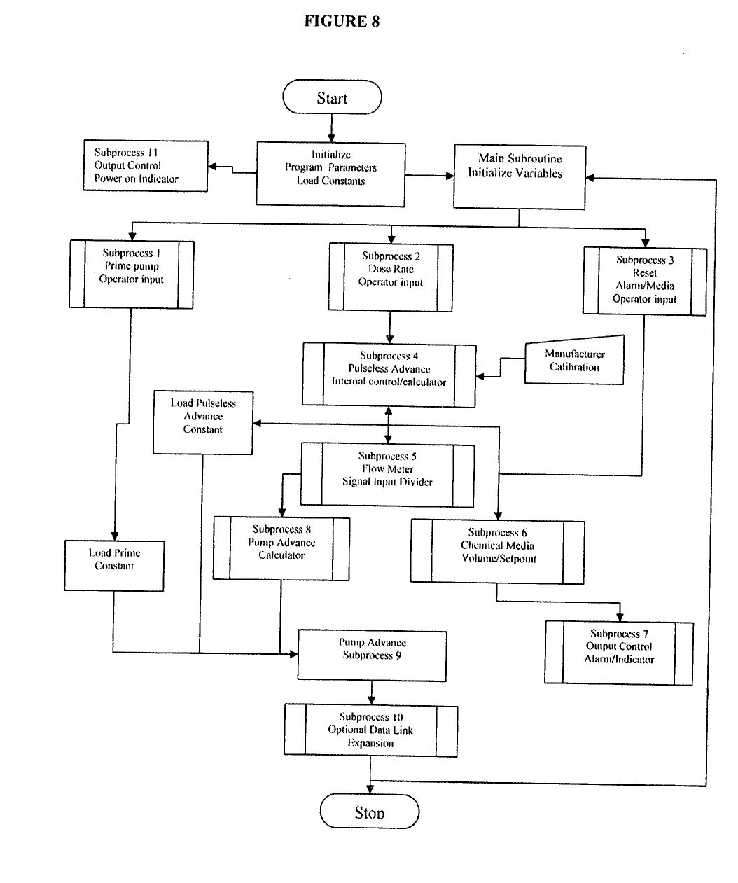

FIG. 8 shows an embodiment of a computer program flow chart that can be utilized as part of the present invention. Subprocesses 1, 2, and 3 can involve operator input and allow the user to control priming the pump (subprocess 1), determining dose rate (subprocess 2) and determining the values for the alarm indicators (subprocess 3). The rest of the subprocesses allow the system to inject the chemical(s) using the dose rate set by the user. Of course, the dose rate can also be set by others without any direct input by the user.

In yet another general aspect, the invention provides automated methods of injecting or metering chemicals into at least one liquid to treat the liquid. Accordingly, the invention provides automated methods of treating or purifying a liquid. In general, the method comprises: releasing a chemical(s) from a containment means; exposing the liquid that is to be treated with the chemical(s); and allowing at least one molecule of the liquid to be treated with the chemical. In an optional step, the chemical(s) is added to the containment means before it is released from the containment means. In preferred embodiments, the liquid that is being treated is water. In the method, most of the steps are performed automatically by a machine, such as one controlled by a computer program. Therefore, using another perspective, the present invention provides an automated method for the treatment of a liquid, by means of the mechanical displacement of liquids, wherein the method comprises causing the release of at least one chemical from a containment means, causing the exposure of the liquid that is being treated to the chemical(s), and allowing at least one molecule of the liquid to be treated with the chemical(s). The liquid that is being treated may be for a household sized application, such as for treatment of water. In this automated method, the movement of fluids may be automatically controlled by a computing device.

The methods of the apparatus are automated, meaning that the steps of the methods occur mechanically and substantially without the intervention of a human. In a preferred embodiment, the methods of treatment of liquids take place in the system of the present invention. In this case, the method comprises allowing the liquid to flow through the system and allowing treatment of the liquid to occur. As such, “automated” includes a meaning by which, in general, no human intervention is required after allowing flow of the liquid through the system until at least one molecule of liquid is treated. In the system of the invention, the liquid and chemical are primarily transferred through the instrument by the mechanical displacement of liquids.

The methods of the present invention are typically implemented via computer programs. The instrument can have computer programs already preprogrammed into it and/or the user can program custom methods into the system. Different programs can be added to the instrument depending on the method for treatment of the liquid. Computer programs already installed in the machine can be changed to reflect different methods and goals. In some embodiments, parts of the instrument can be taken out and exchanged for another part that is better suited for a specific method.

It will be apparent to those skilled in the art that various modifications and variations can be made in the practice of the present invention and in construction of the system and instrument without departing from the scope or spirit of the invention. Other embodiments of the invention will be apparent to those skilled in the art from consideration of the specification and practice of the invention. It is intended that the specification and examples be considered as exemplary only, with a true scope and spirit of the invention being indicated by the following claims.

1. A system that treats a fluid, said system comprising:
at least one chemical storage container;
at least one pump for pumping chemical from the chemical storage container to a container comprising a fluid to be treated;
at least one pump controller to cause pulseless movement of fluid from the pump(s);
at least one flow monitor assembly to monitor the amount of chemical added to the fluid to be treated; and
at least one conduit for conducting the chemical from the chemical storage container to the container comprising the fluid to be treated.

2. The system of claim 1, further comprising a power supply.

3. The system of claim 1, wherein the system does not comprise any open containers.

4. The system of claim 1, wherein the system is used for water treatment or purification.

5. The system of claim 1, wherein the system is capable of treatment of water for a single household.

6. The system of claim 1, further comprising a computing device, wherein the system is an automated system in which movement of fluid and chemicals is controlled by the computing device.

7. The system of claim 1, wherein said chemical storage container, power supply, pump, pump controller, and flow monitor assembly are enclosed in a single shell, and wherein the system is portable.

8. The system of claim 1, wherein the chemical storage container is disposable.

9. The system of claim 1, wherein monitor assembly comprises a dip tube, dip tube connector, and supply tubing, which comprise one piece.

10. The system of claim 1, wherein the system comprises a power supply, which is a VDC power supply.

11. The system of claim 1, wherein said pump controller comprises a pulseless cam and switch.

12. The system of claim 1, wherein the chemical dosing rate into the fluid that is being treated is approximately at or below 0.1 milligrams/liter.

13. An instrument for precise addition of at least one chemical into a fluid, said instrument comprising:
at least one pump to pump at least one chemical from a first container into a second container containing a fluid to be treated with the chemical;
at least one conduit connecting the pump(s) to the second container;
at least one pump controller to cause the pump(s) to move fluid in a pulseless manner; and
at least one flow monitor to monitor the flow of chemical(s) into the second container;
wherein the instrument is capable of precise, constant delivery of chemical to the fluid at less than 1 part per million variance.

14. The instrument of claim 13, further comprising at least one power supply for powering the pump(s), controller(s), and/or monitor(s).

15. The instrument of claim 13, wherein the instrument is capable of delivery of chemical at less than 100 parts per billion variance.

16. The instrument of claim 13, wherein the fluid is water.

17. An automated method for the treatment of a liquid by means of the mechanical displacement of liquids, said method comprising:
causing the release of at least one chemical from a containment means;
causing the exposure of the liquid that is being treated to said at least one chemical; and
allowing at least one molecule of said liquid to be treated with said at least one chemical.

18. The method of claim 17, wherein the liquid that is being treated is water.

19. The method of claim 17, wherein the liquid that is being treated is for a household sized application.

20. The method of claim 17, wherein movement of fluids is automatically controlled by a computing device.
